(19) United States
(12) Patent Application Publication
(10) Pub. No.: US 2004/0025053 A1
(43) Pub. Date: Feb. 5, 2004

(54) Personal data device and protection system and method for storing and protecting personal data

(76) Inventor: Philip John Hayward, Bagshot (GB)

Correspondence Address: WILDMAN, HARROLD, ALLEN & DIXON, 225 WEST WACKER DRIVE, CHICAGO, IL, 60606, US

(21) Appl. No.: 10/344,109

(22) PCT Filed: Jul. 25, 2001
(86) PCT No.: PCT/GB01/03342

(30) Foreign Application Priority Data
Aug. 9, 2000 (GB) 0019628.6
Sep. 18, 2000 (GB) 0022848.6

(51) Int. Cl. H04L 9/32; G06F 15/16; H04L 9/00

(52) U.S. Cl. 713/201; 705/51; 713/150; 709/217

(57) ABSTRACT

A personal data device, system and method for storing personal data including authentication means for restricting access to the stored personal data to an authorized user and communication means for transferring at least some of the personal data between the personal device and a server. A copy of the personal data is stored on a database server and the data on the personal data device and the data on the database server is mutually updated and synchronized by communications over a communications network. A facility is supplied to delete the personal data stored on the personal data device when attempts are made by an unauthorized user to use the personal data device. The personal data may subsequently be reloaded into the personal data device, or into a replacement personal data device, from the database server.

The present invention relates to personal data storage and protection.

Personal data devices, for example digital personal assistants, lap top computers, personal computers or similar devices are known for storing personal data in associated memory modules, for example, to act as personal organisers. However, in order to use the stored data the data has to be displayed on a display and to be manually read out or re-keyed into another device.

There are proposals to use short-range radio communications in such devices for communicating with, for example, computer peripherals. For example, so-called Bluetooth technology has been proposed, for example, for transmission of data and media files, for use for communicating with point of sale terminals, for loading money into electronic wallets, for automatic checking in at hotels and airports, for payment in stores and restaurants, for remote switching on and off of lights and heating and remote locking of doors. Bluetooth is a global standard using a 2.4 GHz frequency band, working over a typical range of up to 100 metres.

However, such applications in relation to a personal data device are susceptible to misuse. It is an object of the present invention to provide greater security of such stored personal data.

According to a first aspect of the invention there is provided a personal data device including storage means for storing personal data and/or software, authentication means for restricting access to the stored personal data and/or software to an authorised user, communication means for transferring at least some of the personal data and/or software between the personal data device and a server for uploading the at least some of the stored personal data and/or software to the server to maintain a duplicate copy of the at least some of the stored personal data and/or software on the server, and deletion means to delete the at least some of the data and/or software stored in the storage means to protect the personal data and/or software from unauthorised use.

Preferably, the deletion means is adapted to delete the at least some of the data and/or software when an attempt is made by an unauthorised user to use the personal data device.

Conveniently, the deletion means is adapted to delete the at least some of the data and/or software when authentication criteria of the authentication means are not met after a predetermined plurality of attempts.

Alternatively, the deletion means is adapted to delete the at least some of the personal data and/or software on receipt of a signal from the server.

Preferably, the personal data device is provided with uninterruptable standby power supply means sufficient to power receiving means for the reception of the signal from the server and to power the deletion means to delete the personal data and/or software.

Alternatively, the deletion means is adapted to delete the at least some of the personal data and/or software after a first predetermined period of time of non-use of the personal data device and/or after a second predetermined period of time since synchronising the personal data device with the server.

Conveniently, the deletion means is adapted to delete the at least some of the personal data and/or software without an unauthorised user being made aware that deletion is taking place.

Advantageously, the deletion means is adapted to reset variables stored in the personal data device to default values.

Preferably, the personal data device includes means to download personal data and/or software from the server.

Advantageously, encryption means and decryption means are provided for storing the personal data and/or software on the personal data device in an encrypted format.

Preferably, the personal data device includes means for establishing communications with the server to upload new or amended stored personal data and/or software to the server after a predetermined number of additions or amendments to the stored data and/or software have been made.

Advantageously, the communications means includes means for transferring at least some of the stored personal data between the personal data device and a transaction terminal for performing a transaction at the transaction terminal.

Preferably, the communication means includes short-range wireless first communication means for communicating with the transaction terminal; and second communication means for connection to a network for communicating with the server.

Conveniently, the short-range wireless communications means is adapted to operate over a range up to 100 metres.

Advantageously, the authentication means includes pattern recognition means.

Conveniently, the pattern recognition means is adapted to recognise at least one of the authorised user's fingerprint pattern, iris pattern and voice pattern.

Conveniently, the storage means is adapted to store data updatable only by a corresponding issuing authority and to store user data updatable by the authorised user.

Preferably, the storage means is adapted to store data including data corresponding to any one or more of a credit card, a debit card, a passport, social security data, a driving licence and a membership pass.

Advantageously, the storage means is adapted to store electronic cash and/or travellers' cheques.

Conveniently, the storage means is adapted to store data updatable by an issuing authority, including any one or more of tickets, boarding passes, prescriptions and hotel room access keys.

Conveniently, the storage means is adapted to store data relating to a user's home and/or car, including any one or more of access keys, alarm control, automatic door and gate control.

Advantageously, the storage means is adapted to store user-updatable data including any one or more of multimedia files, address book entries, business cards, appointment diary, bank details, insurance details, donor card and medical history.

According to a second aspect of the invention, there is provided a personal data protection system comprising: a personal data device including storage means for storing personal data and/or software and deletion means for deleting at least some of the personal data and/or software to protect the at least some of the personal data and/or software from unauthorised access; and a database server connectable to the personal data device for storing a copy of the at least some of the personal data and/or software such that the data in the personal data device and the data in the database server may be mutually updated and synchronised.

Preferably, the database server is provided with signalling means to communicate with the personal data device to signal the deletion means to delete the at least some of the personal data and/or software.

Conveniently, the database server includes personal data device status recording means such that the signalling means signals the personal data device to delete the at least some of the personal data and/or software stored in the personal data device on the status recording means being updated that the personal data device has been reported lost or stolen.

Advantageously, the data protection system includes communications means for connecting the database server to the personal data device over a communications network.

Conveniently, at least one of the personal data device and the database server includes encryption means and decryption means such that the personal data and/or software may be stored in an encrypted format.

Advantageously, the data protection system further comprises an issuing authority server having issuing authority communication means for updating the personal data stored in the personal data device.

Preferably, the issuing authority server is connectable to the server for updating the personal data stored in the server.

Advantageously, the database server includes data comparison means for comparing a first version of the personal data uploaded from the personal data device and a second version of the personal data stored in the database server and means to extract a current version of the data from the first and second versions from which to form a synchronised version to replace data stored on both the personal data device and the database server.

Conveniently, replacement means are provided to replace a personal data device that has been reported lost or stolen with a replacement personal data device into which the personal data and/or software stored in the database server may be reloaded.

Preferably, the database server is provided with means to download a user's personal data to a personal computer.

Advantageously, the means to download a user's personal data to a personal computer includes means to download the personal data for storing in an encrypted format on the personal computer.

According to a third aspect of the invention, there is provided a method for storing and protecting personal data comprising the steps of: a) providing a personal data device including storage means for storing personal data and/or software, authentication means for restricting access to the personal data and/or software and deletion means for deleting at least some of the stored data and/or software to prevent unauthorised access thereto; b) storing personal data and/or software in the storage means; c) providing a database server connectable to the personal data device for storing a copy of at least some of the personal data stored in the personal data device; d) mutually updating and synchronising the at least some of the data and/or software stored in the personal data device and the copy of the at least some of the data stored in the database server; and e) deleting the at least some of the data and/or software stored in the personal data device when an attempt is made to gain unauthorised access to data stored in the personal data device.

Conveniently, step e) is performed when the authentication means detects an unauthorised attempt to access the at least some of the stored personal data and/or software.

Alternatively, step e) is performed when the authentication means detects more than a predetermined number of unsuccessful attempts to meet authentication requirements of the authentication means.

Preferably, the personal data device is provided with first short-range wireless communication means, and second communication means for communicating over a communications network and step b) of storing personal data and/or software in the storage means includes using the second communication means to communicate over the communications network with an issuing authority server connected to the communications network and/or by using the first communication means to communicate with an issuing authority terminal having short-range communications means.

Conveniently, the method includes the step of providing a service provider transaction terminal having short-range wireless communication means and using the personal data device first communication means to communicate stored personal data between the personal data device and the transaction terminal to initiate a transaction on the transaction terminal.

According to a fourth aspect of the invention, there is provided a computer program comprising code means for performing the steps of the method described above, when the program is run on one or more computers.

Conveniently, the computer program is embodied on a computer-readable medium.

According to a fifth aspect of the invention, there is provided a computer program product comprising program code means stored in a computer-readable medium for performing the method described above, when that program product is run on one or more computers.

Specific embodiments of the invention will now be described by way of example with reference to the accompanying drawings, in which:

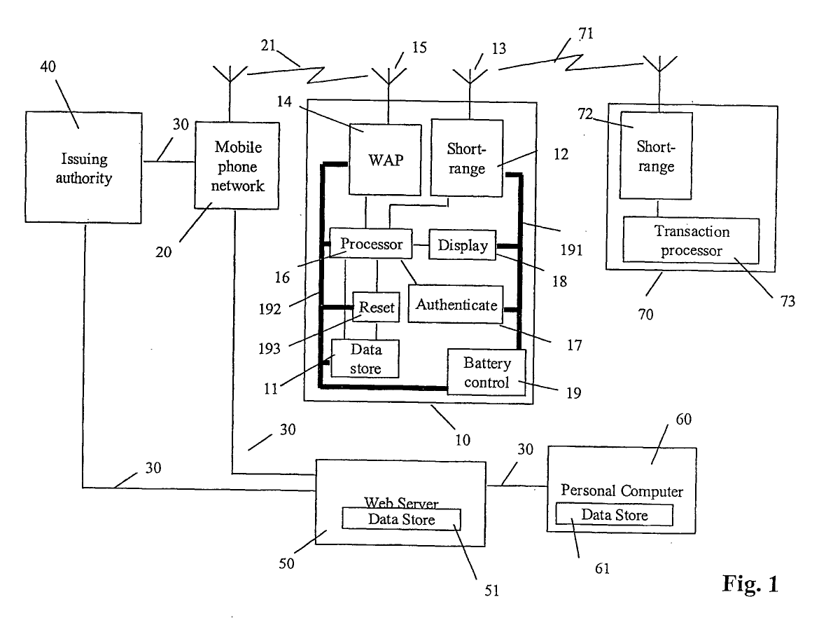

FIG. 1 shows a schematic block diagram of the system;

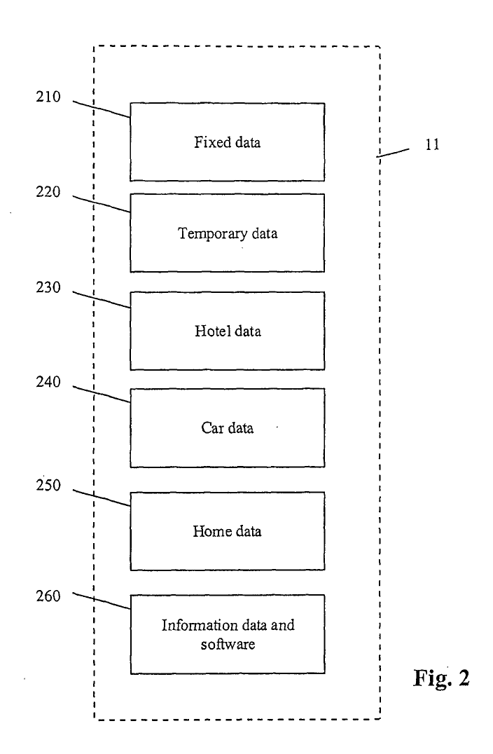

FIG. 2 shows groups of personal data stored in the personal data device used with the system of FIG. 1;

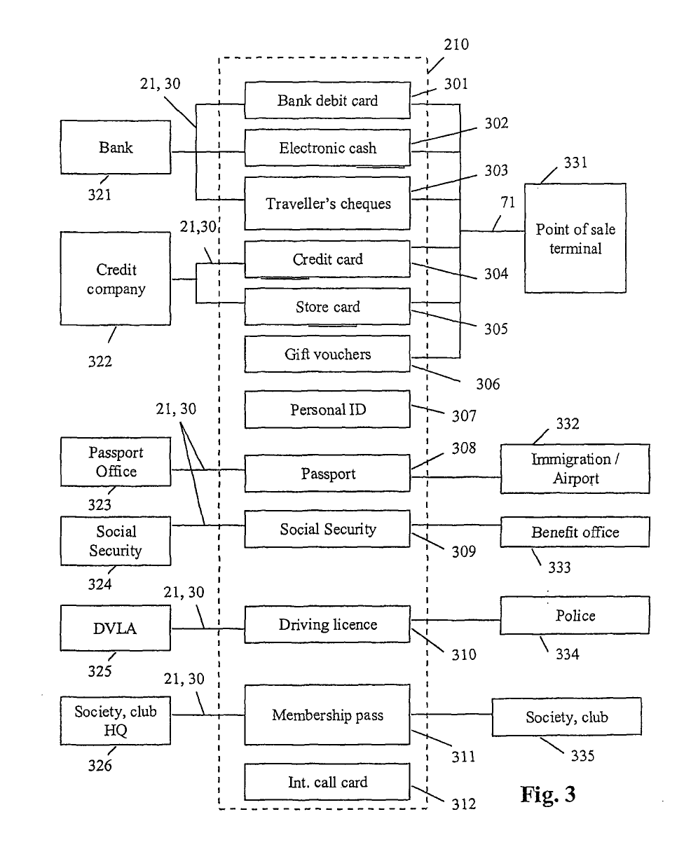

FIG. 3 shows fixed data of FIG. 2, and examples of downloading and uploading the fixed data;

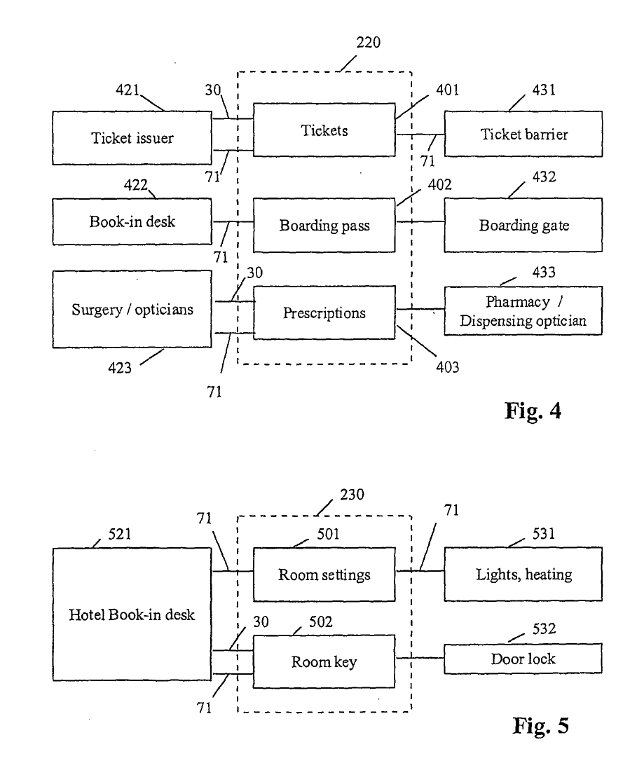

FIG. 4 shows temporary data of FIG. 2, and examples of downloading and uploading the temporary data;

FIG. 5 shows hotel data of FIG. 2, and examples of downloading and uploading the hotel data;

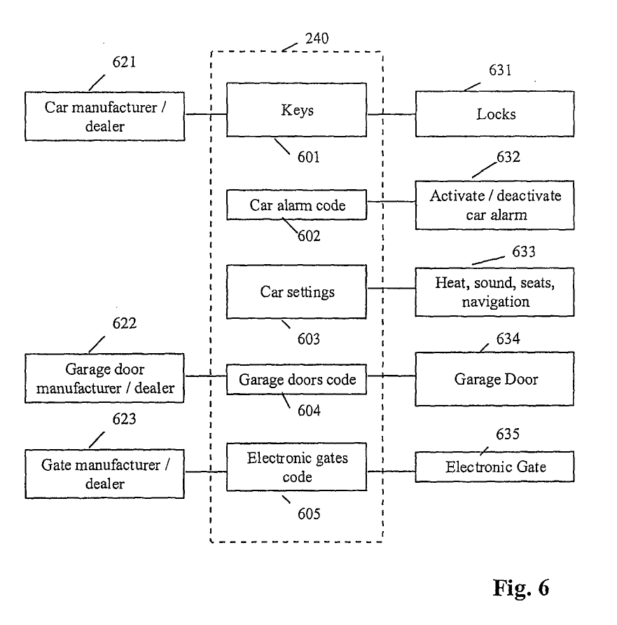

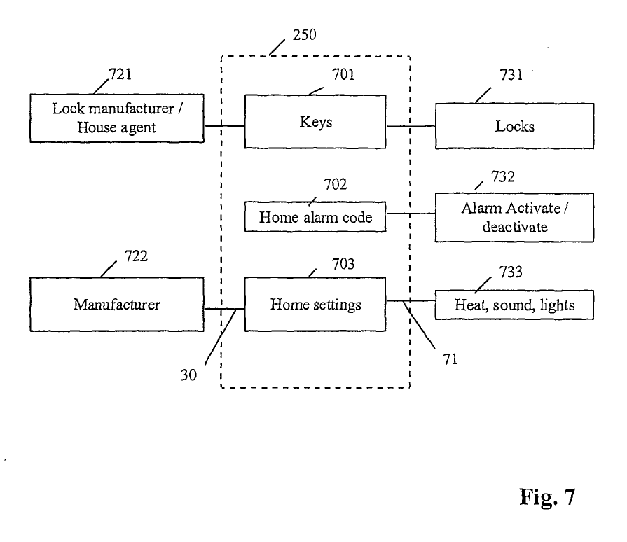

FIG. 6 shows car data of FIG. 2, and examples of downloading and uploading the car data;

FIG. 7 shows home data of FIG. 2, and examples of downloading and uploading the home data;

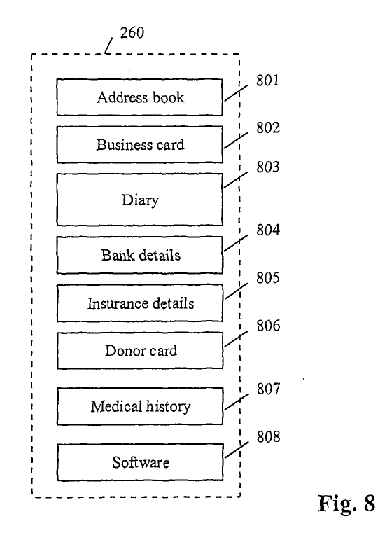

FIG. 8 shows information data of FIG. 2;

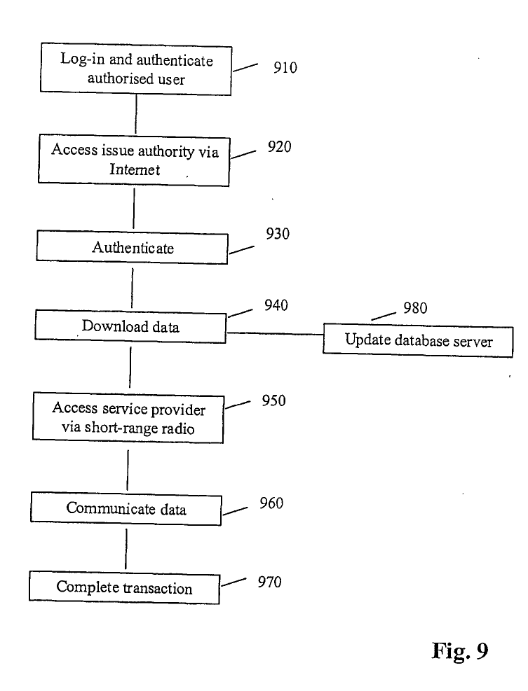

FIG. 9 is a flowchart showing the method of downloading data to and communicating data from the personal data device used with the system shown in FIG. 1;

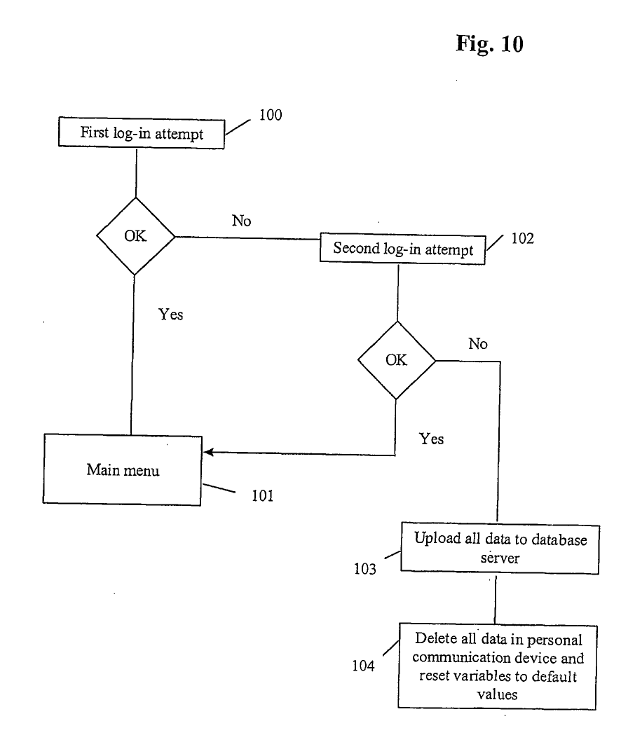

FIG. 10 is a flowchart of the logging in step of the method of FIG. 9;

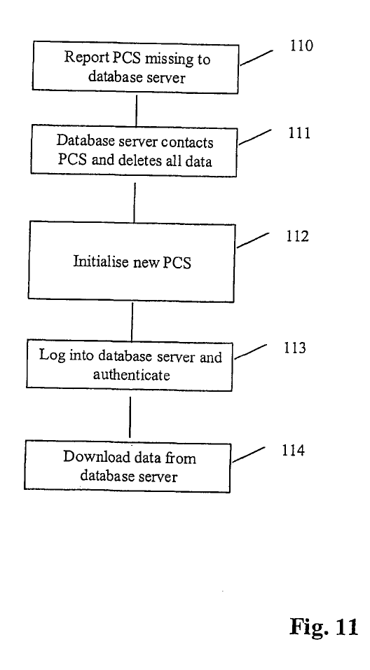

FIG. 11 is a flowchart of the procedure followed when a personal data device of the system of FIG. 1 is found to be missing.

In the figures, like reference numerals denote like parts or steps.

As shown in FIG. 1, the system of one aspect of the invention includes a personal data device 10 including a data store 11 accessible by a processor 16. Also connected to the processor is a short-range radio communications transmitter/receiver 12, connected to a first radio antenna 13, and a mobile telephone transmitter/receiver 14 connected to a second radio antenna 15. The mobile telephone transmitter/receiver 14 is adapted to use a mobile telephone network 20 over a radio link 21 to access an Internet network 30. It will be understood that the antennas 13 and 15 may be combined into a single antenna. Also connected to the processor is an authentication device 17 and a display 18. These components of the personal data device are powered by battery controlled by a battery control 19 through first and second separate power buses 191 and 192, for a reason to be discussed below. The power bus 192 also powers a reset facility 193.

By means of the Internet 30, the personal data device 10 may be connected to an issuing authority web-site server 40 or a web-site database server 50. The database server 50 is provided with a data store 51.

The database web-site server is also connectable by the Internet 30 to a personal computer 60 having a data store 61.

Using the short-range radio transmitter/receiver 12 the personal data device 10 may also be in radio communication over a radio link 71 with a transaction terminal 70 equipped with a compatible short-range transmitter/receiver 72 in communication with a transaction processor 73 within the transaction terminal.

The short-range transmitter/receivers 12, 72 may conveniently use the known so-called Bluetooth protocol.

As shown in FIG. 2, the personal data device data store 11 may include groups of data as follows: multimedia data, personal and/or corporate data, fixed data 210, temporary data 220, hotel data 230, car data 240, home data 250 and information data and software 260. These types of data are given for illustration only and one or more such grouping or different groupings may be used. Moreover, the method of organisation of the data does not form part of the invention and any convenient known method of organising the data may be used. Furthermore, the physical storage means used for storing the data is irrelevant to the invention.

Preferably encryption/decryption facilities are provided such that the data may be stored in an encrypted format.

The fixed data 210 is shown in greater detail in FIG. 3, which shows examples of the types of fixed data 301-312, such as debit card details 301, that may be held. This data is obtained from issuing authorities 321-326 and the data is used to obtain services from service providers 331-335 in a manner to be described.

The temporary data 220 stored in the personal data device 10 is shown in greater detail in FIG. 4, with examples of data relating to a ticket 401, a boarding pass 402 and a prescription 403 with indications of the respective issuing authorities 421-423 and the service providers 431-433.

An example of hotel data 230 stored in the personal data device 10 is shown in FIG. 5, namely room settings data, such as lighting and heating remote control codes 501 and room key data 502 which are entered into the personal data device 10 from the hotel booking desk 521 and subsequently used to set the room lighting and heating 531 and operate the room lock 532 in a manner to be described.

FIG. 6 shows examples 601-605 of car data 240 which may obtained, for example, from the user's car manufacturer or dealer 621 and stored in the data store 11 of the personal data device 10 and subsequently used to operate locks 631, a car alarm 632 or other accessories 633. In addition data 604, 605 may be downloaded from the respective manufacturers 622, 623 of doors 634 and gates 635 so that they may be operated from the personal data device.

Similarly, FIG. 7 shows corresponding home data 250 which may be stored, such as door key codes 701, alarm codes 702 and heat, light, audio and video codes 703 that may downloaded, for example, from a house agent or corresponding manufacturer 721, 722 and subsequently used to operate the corresponding devices 731-733.

A further example of a data grouping is so-called information data and software 260 shown in FIG. 8. This may include such semi-permanent updatable data as an address book 801, a business card 802, an appointments diary 803, bank details 804, insurance details 805, a donor card 806 and the user's medical history 807. This may include a copy of the current version of software 808 used on the personal data device so that this software may also be protected as well as the data in a manner to be described.

The method of operation of the personal data storage and protection system in its most general form is shown in the flowchart of FIG. 9. Referring also to FIG. 1, the personal data device 10 may have the functions of a known mobile telephone or a digital personal organiser, but is further provided with an authentication device 17 such as a fingerprint, iris pattern, voice recognition, personal identity number or other authentication protection. On first use of the device the user's fingerprint or iris pattern, for example, are registered by the device in a manner known, per se. On subsequent use of the personal data device 10 on logging in, step 910, the fingerprint, iris pattern or voice print, for example, is compared with the registered pattern to determine whether the user is registered to use the device before allowing access to the stored data. A timing function may be provided to disable the device after a user-variable period of non-use.

As shown in FIG. 1, associated with the personal data device 10 is a database server 50 having a database data store 51 in which can be stored a copy of the data to be stored in the personal data device. Preferably the database server includes encryption/decryption facilities so that the personal data may be stored in an encrypted format. The database server 50 may conveniently be a server connected to the Internet 30. In this case it is possible for the personal data device to communicate with the server over a mobile telephone link 21 from the mobile telephone compatible transmitter/receiver 14,in the personal data device to access the Internet 30. On first logging into the personal data device 10, it is therefore necessary to log into and register the personal data device with the Internet database server 50. This registration, as well as submitting usual identification data includes transmitting to the database server the registered fingerprint or iris pattern or other authentication data registered in the personal data device for a purpose described below. The data stored on the database server is protected in known ways from unauthorised access, preferably including password protection and encryption to at least a standard set by national or international standards bodies. Arrangements may be made to pay a registration fee on registering with the database server. On registration, the database server may download to the personal data device such additional software as is necessary to operate the invention.

Having registered with the database server 50, it is necessary to populate the personal data device with personal data to be protected. This may be conveniently performed using the Internet connection by accessing, step 920, an issuing authority and downloading data, step 940, after suitable authentication, step 930, see FIG. 9. For example, referring to FIG. 3, data normally stored on a debit card can be downloaded, step 940, to the personal data device to be stored as bank debit card data 301 by connecting the personal data device using the mobile telephone link 21 to the Internet 30 and then accessing a bank's server 321.

Alternatively, if the bank server, or a terminal connected to the server, is equipped with short-range wireless communications facilities using the same protocol, such as Bluetooth, which is used by the short-range transmitter/receiver 12 of the personal data device, then the data can be downloaded onto the device using the short-range wireless link 71 when the personal data device is within range of the bank server's transmitter/receiver.

In a similar manner electronic cash 302 or traveller's cheques can be downloaded into the personal data device either using the Internet 30 or by using a Bluetooth equipped terminal similar to a known Automatic Teller Machine, and the user's bank account debited.

In addition, credit card data 304 and store card data 305 can be downloaded from a credit company server 322, preferably including the user's current credit limits. Alternatively, the device may include facilities for checking the status of the user's account on demand.

Gift voucher data 306 may be entered into the data store 11, for example, when received from, or on the instructions of, a donor by email.

With such data loaded in the personal data device the user may use the personal data device to make payments, for example at retail outlets such as shops and restaurants. In order for the user to be able to make payments the retail outlet is equipped with a point of sale terminal 331 having short-range wireless communications functionality using the same communications protocol as the personal data device, for example, the Bluetooth protocol. In logging into the personal data device the user is identified as an authorised user by the fingerprint, iris pattern or other authentication facility 17. This prevents the device being fraudulently used to make payments by an unauthorised user. A communications link 71 is then established, step 950, FIG. 9, between the point of sale terminal and the personal data device. The cost of the transaction is communicated to the personal data device from the point of sale terminal, the user selects a method of payment, for example by credit card, debit card or electronic cash, and authorises the payment. The user's data record is debited with the corresponding amount and, for example, if credit card payment has been selected, the user's credit card details 304 are uploaded, step 960, FIG. 9, to the point of sale terminal 331 and the retailer's account subsequently credited by obtaining a refund from the credit company or bank in a known manner, step 970. Where required, the transaction may be further authenticated by an electronic signature. Alternatively, electronic cash, for example, may be transferred from the personal data device to the transaction terminal.

If the personal data device credit card data also includes the user's current credit limit, there is no requirement for the retailer to receive authorisation from the credit card company before accepting payment since a credit check can be carried out directly with the personal data device. In addition, the user's available credit limit in his personal data device can be immediately debited by the value of the transaction to indicate the user's new available credit limit. The current value of credit available will obviously be raised again when the user next makes a payment to the credit card company, in a manner to be described. When the user makes credit card payments, other than by using the personal data device, the available credit limit may also be updated by the credit card company by updating the personal data on the database server so that the corresponding data on the personal data device may subsequently be updated.

The personal data device may also hold many other types of data as illustrated in FIG. 3. For example, personal identification data 307, or passport data downloaded from a passport issuing authority 323, in an analogous manner to that in which the monetary data is downloaded. Such data would typically include a passport-type photo of the authorised user. The personal data device may then be used at, for example, an airport check-in desk or a port of entry to communicate with a Bluetooth-equipped terminal so that the passport data, including the stored photograph, may be displayed to an operator or used in, for example, automatic validation or immigration checks without any requirement for the operator to key in the data.

As illustrated in FIG. 3, the stored data may also include social security data 309 downloaded from Social Security authorities 324 and used for example for claiming benefit at benefit offices 333. Such payments could be in the form of electronic cash 302 paid into the personal data device. Similarly, driving licence data 310 may be downloaded from a driving licence authority 325 and read automatically by, for example, police officers equipped with Bluetooth compliant equipment 334, again without the delay or possibility of error associated with the data being keyboarded by a remote police operator. In another application, membership details may be downloaded from, for example, a club or society Internet website automatically to grant the user privileges of membership when the user's device is read by Bluetooth compliant equipment 335. International calling card data 312 may also be held with the fixed data 210.

Referring to FIG. 4, the personal data device can also be used to store less permanent or temporary data 220. For example, the device may store ticket details 401, for example for transport or entertainment. Thus, a train season ticket or airline ticket may be bought online over the Internet 30 using the device's mobile telephone facilities 14 or from a booking office using the short-range wireless link 71. The device then may be used to gain entrance through a ticket barrier 431 that is, for example, Bluetooth-compliant. Similarly, boarding pass data 402 can be downloaded over the Bluetooth-compliant wireless link 71 at an airport check-in desk and then read, and if required, deleted, at a Bluetooth-compliant equipped boarding gate 432. In addition, prescription data 403 can be downloaded at a doctor's or optician's surgery using Bluetooth-compliant terminal and read and if required deleted using another Bluetooth-compliant terminal 433 at a pharmacy or dispensing optician respectively. Alternatively, if a medical condition is diagnosed by a doctor from a location remote from a patient, or for repeat prescriptions, the prescription may be downloaded to the patient's device using the Internet 30.

As shown in FIG. 5, the invention also has application in an hotel environment. On booking into the hotel at a check-in desk 520 a code for an assigned room key 502 may be downloaded into the personal data device 10 and then the data used to unlock and lock the room door 532 by transmitting the stored code to the door lock using another Bluetooth compliant wireless link 71. Similarly, room setting codes 501 may be downloaded to allow the device to be used remotely to control the room lighting and heating, for example. In an embodiment of the invention, the device may establish a communication link 71 with the remote light control, for example, when the device comes within range of the control and cause the display of an icon depicting the light switch on a display of the personal data device. As an alternative to the data being loaded at the hotel check-in desk, where a room is booked in advance, time-limited data may be downloaded remotely, using, for example, the Internet 30, into the user's personal data device, thereby hastening checking in, or avoiding the need to check in on arrival. Where the data is not time-limited, so that the data 230 is not automatically deleted from the personal data device at the end of the booked stay, the data may be deleted as part of the checking-out procedure.

As shown in FIG. 6, the invention also has application in relation to data 240 related to use of a car. In a manner analogous to the hotel application the personal data device may be used to store key codes 601, alarm codes 602 and codes 603 for the operation of such accessories as heating, audio, seat adjustment and navigation controls. These codes may, for example, be remotely downloaded from the car or accessory manufacturer's server 621 or downloaded locally or remotely from a car dealer. Alternatively, where new accessories are added to a car, they may be supplied with a barcode or other machine-readable device for entering the code 603 into the personal data device. In an analogous manner, codes 604,605 may be downloaded from respective manufacturers 622, 623 for operating a remotely controlled garage door 634 or a gate 635.

The system of the invention also has application for data 250 used in a home, as illustrated in FIG. 7, in a manner analogous to that of the car in that key codes 701, alarm codes 702 and other remote control codes 703 can be stored by, for example, downloading from the corresponding manufacturer or house agent 721, 722 and used to operate Bluetooth-compliant locks 731, alarms 732 and other devices 733. When the personal data device is brought within range of a Bluetooth terminal in the user's home, the device may initiate the turning on of lights, and setting heating to a predetermined temperature.

Referring to FIG. 8, the personal data device may also be used to store other variable data 260, in a known manner, which may, for example, be entered from a keyboard, or downloaded from a personal computer 60 in a manner to be described. Thus the device may incorporate an address book 801, an appointments diary 803 as well as a business card 802, which may be emailed over the Internet 30 or transmitted by a Bluetooth link 71 to another personal data device. The device may also be used to store, for example, insurance details 805, donor card data 806 and the user's medical history 807. It will be appreciated that the medical history may then be read and updated in any medical consultation, intervention or emergency by Bluetooth-compliant equipment.

Facilities may be provided for emergency access to the medical history data, which bypasses the authentication facilities for use when the authorised user is unconscious or otherwise incapacitated.

As indicated above, and referring again to FIG. 1, the personal data device is also connectable, for example using the Internet 30, to a database server 50 having a database data store 51 for storing a copy of the data stored in the data store 11 of the personal data device 10. The database server may thus be used to store a duplicate version of the data and software stored in the personal data device. It is therefore necessary for the personal data device to be logged into the database server from time to time to synchronise the data stored on the personal data device and on the database server. For example, the personal data device may contact the database server 50 over the internet 30 every time an amendment or addition is made to the personal data stored on the personal data device. Alternatively, updates may be made after, say, every three changes or at some other frequency chosen by the user. Facilities may be provided on the database server to compare the version of the personal data already stored with the current data in the personal data device and only to copy in either direction, as appropriate, any data which has changed or is new on either the device or the server, to create new current versions on both the device and the server.

This two-way checking is necessary because the database server may also be used to store updates from the issuing authorities, for example a new available credit limit, for example, when a payment is made by the user to the credit card company or when credit card payments are made other than by the personal data device, so that the personal data device may be updated with the new data when the device 10 is next logged into the database server 50.

An authorised user may view his or her personal data stored on the personal data device or on the database server, subject to authorisation. The data may have associated internet addresses of the corresponding issuing authorities, so that a user may, for example, access the issuing authority server to access the user's details or account on the issuing authority server.

The database server also performs an important function when a personal data device is missing or replaced. Referring to FIG. 11, if a personal data device 10 is reported missing, step 110, to the database server 50, the database server seeks to contact the missing device. The device may, for example, be reported missing by contacting the database server via the Internet or telephone. The database server preferably contacts the device in a manner undetectable to a user, for example by a “silent call” over the mobile telephone network 20, when the device is next switched on. Alternatively, the personal data device may be provided with sufficient functionality even when nominally powered off to receive the “silent call” and act upon it. Such functionality may be powered by a main battery of the personal data device or by an auxiliary standby battery. Alternatively, as shown in FIG. 1, the components of the personal data device may be powered by separate power buses 191 and 192. Under normal operation power will be supplied to all the components through both the power buses but in a standby mode, power is supplied only via power bus 192 to the data store 11, processor 16 and mobile telephone transmitter receiver 14. The standby power bus 192 also powers a reset 193 for a purpose to be described. An icon may be displayed on the personal data device display when the device is powered off to indicate that the data is protected by being duplicated on the database server. On being notified that the personal data device is no longer in the possession of the authorised user, the database server compares the data stored in the personal data device with that stored for that device in the database and, if appropriate, updates the version stored in the database using the data stored in the personal data device. The database server then signals the personal data device to delete, step 111, the data held in the personal data device so that the data cannot be used by an unauthorised user, for example, by using the reset facility 193 to reset all variables stored in the personal data device to default values. Moreover, the database server does not authorise subsequent registration of the personal data device with the database server, except by the authorised user. Therefore, even if an unauthorised user manages to bypass the fingerprint or other authentication facility incorporated in the personal data device, the device provides only limited functionality to the unauthorised user. In addition, the data store 11 of the personal data device may be designed to be sufficiently volatile that should a thief remove the power supply to prevent a “silent call” deleting the stored data, the stored data will be automatically deleted and, for example, all variables reset to default values when the power supply is restored. The database server may also contact all issuing authorities to inform them that the device is missing, so that the issuing authorities may, if desired, issue new account numbers, codes or other details for subsequent use by the authorised user on a replacement personal data device. For this purpose, the issuing authority may, after suitable authentication, download the new data into the user's data on the database server to be subsequently downloaded to the user's replacement personal data device.

The authorised user can replace the missing personal data device, or upgrade to a later model, and after initialising, step 112, the new device, can log into the database server 50, step 113, and download, step 114, all, or some of, the user's duplicate data from the database server onto the new personal data device. In order to download the data it is necessary to enter the authorised user's name and password. If the user has forgotten his or her access information the user may, for example, contact a server operator by selecting an icon on the database server website and answer identifying questions either by voice or text communication, in order to obtain access to his or her personal data. The database server will provide an opportunity to remind the user of the registered name and password before the user logs off. Alternatively, where pattern recognition is employed to identify authorised users, this will provide access to the user's personal data on the server either through the user's personal data device or a personal computer, provided the pattern is also stored on the database server. In this manner the user can replace a device and reload the device with data using the Internet, wherever the user may be in the world.

As a further refinement, a facility may be provided on the database server, following a report of a loss of a personal data device, either to despatch a replacement directly to the user or to authorise a local supplier to issue a replacement device to the user. Such a service may be covered by insurance.

As shown in FIG. 10, in an embodiment of the invention, the device may be further protected by automatic deletion of the data stored in the personal data device on failure successfully to log into the personal data device after, for example, a second attempt. Thus, the user makes a first attempt to log into the device, step 100, and if successful is presented, step 101, with a device main menu. If unsuccessful, a second attempt, step 102, may be made and if successful the main menu is presented, step 101. However, if logging in is unsuccessful at the second attempt the device deletes, step 104, all the data in the personal data device. Preferably, before deleting the data, the device contacts the database server 50 and uploads, step 103, at least any data to the database server that is necessary to create a current backup. An authorised user may, subject to proper authentication, subsequently reload the data from the back-up into the personal data device.

In an embodiment of the invention, access is provided to the database server 50 from a user's personal computer 60, as shown in FIG. 1. The user may then maintain a copy of the data stored in the personal data device in a data store 61 of the personal computer. Alternatively, a personal computer could be used to keep the only backup of the personal communications data, without the use of a database server and the personal computer used for all the functions otherwise carried out by the database server. In an embodiment of the invention, where the personal computer is equipped with short-range wireless communications facilities, communication between the personal data device and the personal computer may, in addition or alternatively, be by a short-range wireless link.

1. A personal data device including storage means for storing personal data and/or software, authentication means for restricting access to the stored personal data and/or software to an authorised user, communication means for transferring at least some of the personal data and/or software between the personal data device and a server for uploading the at least some of the stored personal data and/or software to the server to maintain a duplicate copy of the at least some of the stored personal data and/or software on the server, and deletion means to delete the at least some of the data and/or software stored in the storage means to protect the personal data and/or software from unauthorised use.

2. A personal data device as claimed in claim 1, wherein the deletion means is adapted to delete the at least some of the data and/or software when an attempt is made by an unauthorised user to use the personal data device.

3. A personal data device as claimed in claim 2, wherein the deletion means is adapted to delete the at least some of the data and/or software when authentication criteria of the authentication means are not met after a predetermined plurality of attempts.

4. A personal data device as claimed in any of claims 1 to 3, wherein the deletion means is adapted to delete the at least some of the personal data and/or software on receipt of a signal from the server.

5. A personal data device as claimed in claim 4, wherein the personal data device is provided with uninterruptable standby power supply means sufficient to power receiving means for the reception of the signal from the server and to power the deletion means to delete the personal data and/or software.

6. A personal data device as claimed in any of claims 1 to 4, wherein the deletion means is adapted to delete the at least some of the personal data and/or software after a first predetermined period of time of non-use of the personal data device and/or after a second predetermined period of time since synchronising the personal data device with the server.

7. A personal data device as claimed in any of the preceding claims, wherein the deletion means is adapted to delete the at least some of the personal data and/or software without an unauthorised user being made aware that deletion is taking place.

8. A personal data device as claimed in any of the preceding claims, wherein the deletion means is adapted to reset variables stored in the personal data device to default values.

9. A personal data device as claimed in any of the preceding claims, wherein the personal data device includes means to download personal data and/or software from the server.

10. A personal data device as claimed in any of the preceding claims, wherein encryption means and decryption means are provided for storing the personal data and/or software on the personal data device in an encrypted format.

11. A personal data device as claimed in any of the preceding claims, including means for establishing communications with the server to upload new or amended stored personal data and/or software to the server after a predetermined number of additions or amendments to the stored data and/or software have been made.

12. A personal data device as claimed in any of the preceding claims, wherein the communications means includes means for transferring at least some of the stored personal data between the personal data device and a transaction terminal for performing a transaction at the transaction terminal.

13. A personal data device as claimed in claim 10, wherein the communication means includes short-range wireless first communication means for communicating with the transaction terminal; and second communication means for connection to a network for communicating with the server.

14. A personal data device as claimed in claim 11, wherein the short-range wireless communications means is adapted to operate over a range up to 100 metres.

15. A personal data device as claimed in any of the preceding claims, wherein the authentication means includes pattern recognition means.

16. A personal data device as claimed in claim 14, wherein the pattern recognition means is adapted to recognise at least one of the authorised user's fingerprint pattern, iris pattern and voice pattern.

17. A personal data device as claimed in any of the preceding claims, wherein the storage means is adapted to store data updatable only by a corresponding issuing authority and to store user data updatable by the authorised user.

18. A personal data device as claimed in any of the preceding claims, wherein the storage means is adapted to store data including data corresponding to any one or more of a credit card, a debit card, a passport, social security data, a driving licence and a membership pass.

19. A personal data device as claimed in any of the preceding claims, wherein the storage means is adapted to store electronic cash and/or travellers' cheques.

20. A personal data device as claimed in any of the preceding claims, wherein the storage means is adapted to store data updatable by an issuing authority, including any one or more of tickets, boarding passes, prescriptions and hotel room access keys.

21. A personal data device as claimed in any of the preceding claims, wherein the storage means is adapted to store data relating to a user's home and/or car, including any one or more of access keys, alarm control, automatic door and gate control.

22. A personal data device as claimed in any of the preceding claims, wherein the storage means is adapted to store user-updatable data including any one or more of multimedia files, address book entries, business cards, appointment diary, bank details, insurance details, donor card and medical history.

23. A personal data protection system comprising:
a personal data device including storage means for storing personal data and/or software and deletion means for deleting at least some of the personal data and/or software to protect the at least some of the personal data and/or software from unauthorised access; and
a database server connectable to the personal data device for storing a copy of the at least some of the personal data and/or software such that the data in the personal data device and the data in the database server may be mutually updated and synchronised.

24. A personal data protection system as claimed in claim 23, wherein the database server is provided with signalling means to communicate with the personal data device to signal the deletion means to delete the at least some of the personal data and/or software.

25. A personal data protection system as claimed in claim 24, wherein the database server includes personal data device status recording means such that the signalling means signals the personal data device to delete the at least some of the personal data and/or software stored in the personal data device on the status recording means being updated that the personal data device has been reported lost or stolen.

26. A personal data protection system as claimed in any of claims 23 to 25, including communications means for connecting the database server to the personal data device over a communications network.

27. A personal data protection system as claimed in any of claims 23 to 26 wherein at least one of the personal data device and the database server includes encryption means and decryption means such that the personal data and/or software may be stored in an encrypted format.

28. A personal data protection system as claimed in any of claims 23 to 27, further comprising an issuing authority server having issuing authority communication means for updating the personal data stored in the personal data device.

29. A personal data protection system as claimed in claim 25, wherein the issuing authority server is connectable to the server for updating the personal data stored in the server.

30. A personal data protection system as claimed in any of claims 22 to 28, wherein the database server includes data comparison means for comparing a first version of the personal data uploaded from the personal data device and a second version of the personal data stored in the database server and means to extract a current version of the data from the first and second versions from which to form a synchronised version to replace data stored on both the personal data device and the database server.

31. A personal data protection system as claimed in any of claims 22 to 29, wherein replacement means are provided to replace a personal data device that has been reported lost or stolen with a replacement personal data device into which the personal data and/or software stored in the database server may be reloaded.

32. A personal data protection system as claimed in any of claims 22 to 30, wherein the database server is provided with means to download a user's personal data to a personal computer.

33. A personal data protection system as claimed in claim 31, wherein the means to download a user's personal data to a personal computer includes means to download the personal data for storing in an encrypted format on the personal computer.

34. A method for storing and protecting personal data comprising the steps of:
a) providing a personal data device including storage means for storing personal data and/or software, authentication means for restricting access to the personal data and/or software and deletion means for deleting at least some of the stored data and/or software to prevent unauthorised access thereto;
b) storing personal data and/or software in the storage means;
c) providing a database server connectable to the personal data device for storing a copy of at least some of the personal data stored in the personal data device;
d) mutually updating and synchronising the at least some of the data and/or software stored in the personal data device and the copy of the at least some of the data stored in the database server; and
e) deleting the at least some of the data and/or software stored in the personal data device when an attempt is made to gain unauthorised access to data stored in the personal data device.

35. A method as claimed in claim 33, wherein step e) is performed when the authentication means detects an unauthorised attempt to access the at least some of the stored personal data and/or software.

36. A method as claimed in claim 34, wherein step e) is performed when the authentication means detects more than a predetermined number of unsuccessful attempts to meet authentication requirements of the authentication means.

37. A method as claimed in any of claims 33 to 35, wherein the personal data device is provided with first short-range wireless communication means, and second communication means for communicating over a communications network.

38. A method as claimed in claim 36, wherein step b) of storing personal data and/or software in the storage means includes using the second communication means to communicate over the communications network with an issuing authority server connected to the communications network and/or by using the first communication means to communicate with an issuing authority terminal having short-range communications means.

39. A method as claimed in claims 36 or 37, including the step of providing a service provider transaction terminal having short-range wireless communication means and using the personal data device first communication means to communicate stored personal data between the personal data device and the transaction terminal to initiate a transaction on the transaction terminal.

40. A computer program comprising code means for performing the steps of the method claimed in any of claims 33 to 38 when the program is run on one or more computers.

41. A computer program as claimed in claim 39 embodied on a computer-readable medium.

42. A computer program product comprising program code means stored in a computer-readable medium for performing the method described in any of claims 33 to 38 when that program product is run on one or more computers.
